(19) United States
(12) Patent Application Publication
(10) Pub. No.: US 2008/0222148 A1
(43) Pub. Date: Sep. 11, 2008

(54) LEXICOGRAPHICAL ORDERING OF REAL NUMBERS

(75) Inventor: Zvi SCHREIBER, Jerusalem (IL)

Correspondence Address: SIMON KAHN - PYI Tech, Ltd.;c/o LANDONIP, INC, 1700 DIAGONAL ROAD, SUITE 450, ALEXANDRIA, VA, 22314-2866, US

(73) Assignee: GHOST INC., Tortola (VG)

(21) Appl. No.: 12/044,995

(22) Filed: Mar. 9, 2008

Related U.S. Application Data
(60) Provisional application No. 60/893,968, filed on Mar. 9, 2007.

(51) Int. Cl. G06F 17/30

(52) U.S. Cl. 707/7; 707/E17.039

(57) ABSTRACT

A computer implemented method of representing real numbers of positive and negative sign as a character string such that the a lexicographical ordering of the character string matches the numeric ordering of the real numbers. In the method, a real number is expressed as at least one whole number followed by at least one fractional number, times a predetermined base to a whole number exponent. In one embodiment the representation is formed by concatenating, in a predetermined order: a representation of the sign of the real number; a representation of the numeric ordering responsive to the exponent; a representation of the exponent; and a representation of the whole numbers followed by a representation of the at least one fractional number.

### CROSS-REFERENCE TO RELATED APPLICATIONS

This application claims priority from U.S. Provisional Patent Application Ser. No. 60,893,968 filed Mar. 9, 2007, entitled “Virtual Hosted Operating System” the entire contents of which is incorporated herein by reference.

### BACKGROUND OF THE INVENTION

The invention is related to a method of representing numbers and more specifically to a computer implemented method of representing numbers in a database so as to support lexicographical sorting and queries.

Database products are well known to those skilled in the art. Some database products such as relational database products, including those from Oracle Corporation, Redwood Shores, Calif. and from Microsoft Corporation, Redmond, Wash., are able to query data using either numeric ordering or lexicographical ordering. Other databases such as the hosted database service Amazon SimpleDB available from Amazon.com, Inc of Seattle, Wash., allow for the selection and sorting of data in queries based on lexicographical ordering only.

In numeric ordering, numbers are sorted by value, such that, for example, −3<0.5<2<100. In particular, in numeric ordering the number of digits to the left of the decimal place is more significant to the ordering than the value of the leading digit. Furthermore, a leading sign has significant meaning for ordering, with a leading negative sign effectively reversing the order as compared with a leading positive sign. Thus, −9<−5<−0.1<−0.01, whereas +0.01<+0.1<+5<+9.

Lexicographical ordering, as used throughout this application, is the ordering used in dictionaries as extended to include all characters. Lexicographical ordering, when limited to alphabetic characters, is sometimes called alphabetical ordering, and is the ordering used in dictionaries and is often used in mathematics with respect to the more general case of strings or sequences of any ordered elements, not only the alphabet. Lexicographical ordering is characterized by having the leading character being the most significant to the ordering followed by the second character. Lexicographical ordering is accomplished on strings of characters.

In addition to representing the English alphabet, computers require a standardized means for representing all characters, including numbers and control characters. One standard, used widely in computer systems, is the American Standard Code for Information Interchange (ASCII), in which numbers, letters and certain control characters are encoded to standardized values. ASCII is also known as ANSI X3.4 available from the American National Standards Institute, Washington D.C. The inherent need for a standard method of encoding has driven various encoding schemes, many of which are mostly compatible with the ASCII standard. ISO/IEC 646; ISO 8859 and ISO 10646, available from the International Organization for Standardization, Geneva, Switzerland, each represent character encoding schemes for encoding alphanumeric characters, including various national symbols. Each character is encoded by a standardized value.

Lexicographical ordering on any of the encoded values, such as an ASCII string, or an ISO 10646 string, will result in an ordered list of strings in which numeric values precede alphabetic values, and numeric values are sorted such that the leading character is the most significant to the ordering followed by the second character. Such an ordering results in “100”<“2”<“apple”<“banana” which is clearly not consistent with numeric ordering. Therefore, lexicographical ordering does not allow numbers to be queried or sorted in an effective way. For example, in lexicographical ordering “2”>“100”, even though numerically, 2<100.

One known solution to allow lexicographical ordering to properly sort and query numerical values involves representing numbers as fixed length strings by padding the number with leading zeros so as to achieve a predetermined fixed number of digits to left of the decimal place. Such a solution restores the correct order “000000002”<“000000100”, but this technique becomes unwieldy for numbers with too many digits. Additionally, such a solution does not properly resolve negative numbers, in which the sign further reverses the order.

Various alternative encoding schemes for numbers to enable the representation to be used for lexicographical ordering are known to those skilled in the art. However those representations have one or more limitations preventing their use for a full set of numbers.

In particular, prior art methods of encoding numbers for lexicographical ordering do not typically support the use of an exponent to represent extremely large or small numbers using an efficiently small number of characters. In the absence of exponent support, a representation which is N characters long cannot represent a number greater than the base to the Nth power. Thus utilizing numbers expressed in base 10 as a non-limiting example, a representation 15 characters long can not represent a number greater than 10̂15.

Prior art methods of encoding negative numbers into a string for lexicographical ordering typically require adding an offset to make them positive. The size of the offset must be selected so as to be at least as large as the absolute value of the lowest negative number to be encoded. If the magnitude of the offset is big, for example 10̂15, small numbers have long complex representations, for example 1 becomes 1,000,000,000,000,001 and −1 becomes 999,999,999,999,999. If the magnitude of the offset is smaller, than large negative numbers cannot be represented.

In mathematics, it is known that any number can be represented as a fixed number of whole digits, followed by fractional digits, multiplied by a base to an exponent. A delimiter between the whole digits and fractional digits is typically supplied so as to differentiate the whole digits from the fractional digits. In particular, utilizing base 10 as a non-limiting example, any number can be represented as: x.yyyyy*10̂z, in which x represents the whole digit, or digits; the period to the right of x delimits the whole digits; yyyyy to the right of the period represents the fractional digits; and z is an integer which represents the appropriate exponent power. In order to minimize the number of whole and fractional digits required over a range of numbers, and to standardize at a fixed number of whole digits, typically only a single whole digit is utilized, with the exponent selected accordingly.

As indicated above, certain database products only provide for lexicographical ordering. In particular, the type of indexing supplied in these products does not allow numeric orderings to be easily added. The prior art does not supply a solution for encoding numbers into strings, so that a resultant lexicographical ordering of the encoded numbers matches the numerical ordering, and such that positive and negative numbers of a huge range of magnitudes may be represented with a string having a number of characters not greatly exceeding the number of significant decimal places of the numbers to be encoded.

### SUMMARY OF THE INVENTION

Accordingly, it is a principal object of the present invention to provide a computer implemented method of encoding numbers into strings such that positive and negative numbers of a range of magnitudes may be effectively and efficiently encoded in such a way that the lexicographical ordering of the encoding strings matches the numeric ordering.

In one embodiment this is accomplished by resolving the numbers to be encoded to a fixed number of whole digits, followed by fractional digits, multiplied by a predetermined base to an exponent. Complementary digits are used to express negative numbers in either or both of the overall value and the. The sign of each of the overall numerical value and the exponent are further encoded into the resultant string.

In a non-limiting example utilizing base 10, the significant digits are separated from the general magnitude. Complementary digits are used to correct the ordering of negative numbers both in the overall numeric value and negative exponents. The sign of each of the overall numeric value and exponents are further encoded. Preferably, if the number to be encoded is zero, a predetermined character such as the letter “o” is used.

Additional features and advantages of the invention will become apparent from the following drawings and description.

### BRIEF DESCRIPTION OF THE DRAWINGS

For a better understanding of the invention and to show how the same may be carried into effect, reference will now be made, purely by way of example, to the accompanying drawings in which like numerals designate corresponding elements or sections throughout.

With specific reference now to the drawings in detail, it is stressed that the particulars shown are by way of example and for purposes of illustrative discussion of the preferred embodiments of the present invention only, and are presented in the cause of providing what is believed to be the most useful and readily understood description of the principles and conceptual aspects of the invention. In this regard, no attempt is made to show structural details of the invention in more detail than is necessary for a fundamental understanding of the invention, the description taken with the drawings making apparent to those skilled in the art how the several forms of the invention may be embodied in practice. In the accompanying drawings:

FIG. 1 illustrates a high level block diagram of a computing platform in accordance with a principle of the current invention;

FIG. 2 illustrates a high level flow chart of an embodiment of a method of encoding numbers to lexicographically sortable strings according to a principle of the invention;

FIG. 3 illustrates a high level flow chart of an embodiment of a method of decoding numbers from a lexicographically sortable string according to a principle of the invention; and

Table I illustrates a non-limiting example of a representation of various numbers as strings, utilizing base 10, in according with a principle of the invention.

### DETAILED DESCRIPTION OF THE PREFERRED EMBODIMENTS

The present embodiments enable a computer implemented method of encoding numbers into strings such that positive and negative numbers of a range of magnitudes may be effectively and efficiently encoded in such a way that the lexicographical ordering of the encoding strings matches the numeric ordering.

Before explaining at least one embodiment of the invention in detail, it is to be understood that the invention is not limited in its application to the details of construction and the arrangement of the components set forth in the following description or illustrated in the drawings. The invention is applicable to other embodiments or of being practiced or carried out in various ways. Also, it is to be understood that the phraseology and terminology employed herein is for the purpose of description and should not be regarded as limiting.

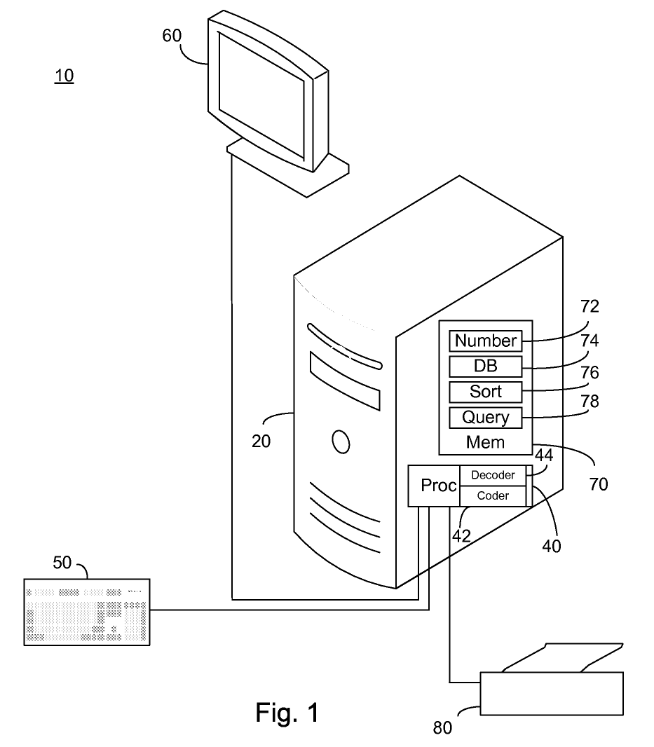

FIG. 1 illustrates a high level block diagram of a computing platform 10 in accordance with a principle of the current invention comprising: a computing device 20 comprising a processor 40 and a memory 70; a user input device 50; a monitor 60; and an output device 80, such as a printer. Memory 70 comprises numbers 72 to be encoded; database 74 incorporating encoded representations of numbers 72; sorting functionality 76 and query functionality 78. Each of sorting functionality 76 and query functionality 78 represent computer readable instructions, enabling processor 40 to perform a respective one of sorting functionality 76 and query functionality 78 on all or a portion of database 74. In an exemplary embodiment each of sorting functionality 76 and query functionality 78 are lexicographical functionalities. Monitor 60 is coupled to an output of processor 40 and an input of processor 40 is connected to user input device 50. Processor 40 is further in communication with memory 70, user input 50 and output device 80.

User input device 50 is illustrated as a keyboard, however this is not meant to be limiting in any way. The use of any or all of a pointing device, a voice input, or a touch screen is equally applicable and is specifically included. Memory 70 is illustrated as being internal to computing device 20, however this is not meant to be limiting in any way. All or parts of memory 70 may be provided external to computing device 20, such as a network server, the Internet, or a removable computer readable media, without exceeding the scope of the invention.

Memory 70 of computing device 20 is further operative to store the method according to the principle of the invention in computer readable format for execution by computing device 20.

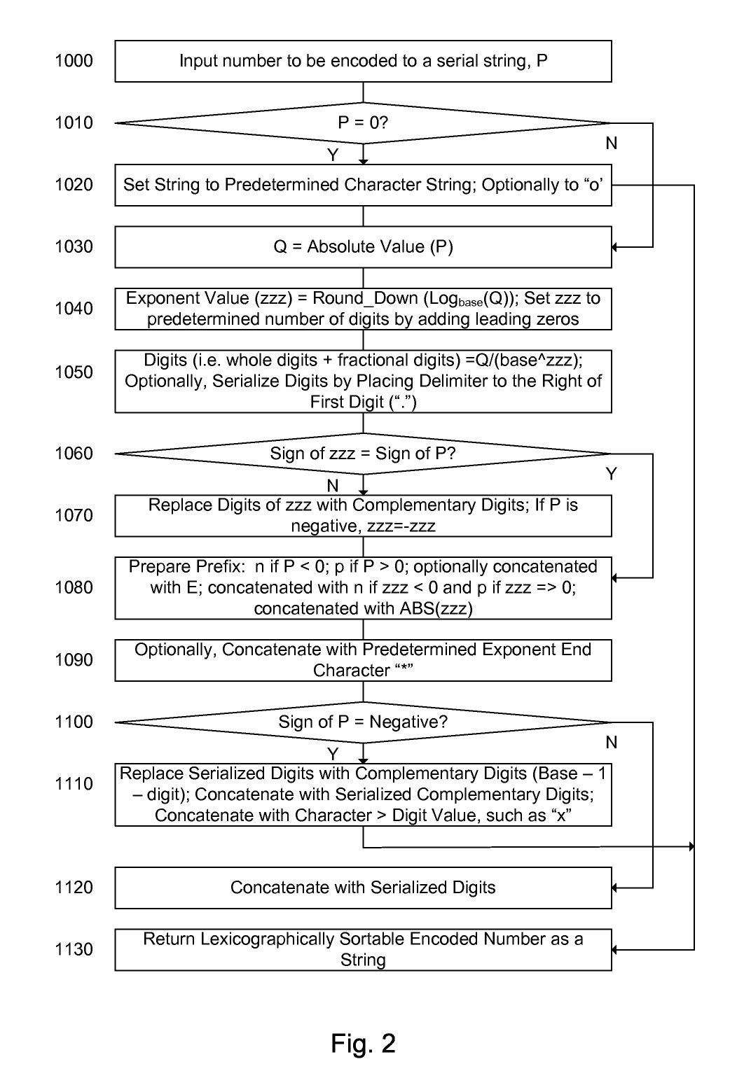

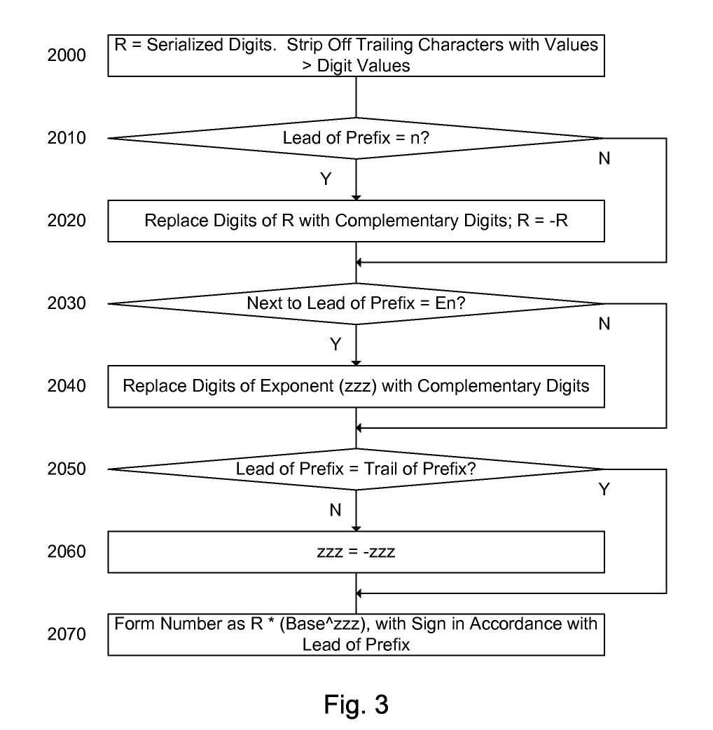

Processor 40, in cooperation with memory 70, comprises an encoding module 42 and a decoding module 44. Encoding module 42, preferably implements the method of FIG. 2, to be described further below. Decoding module 44 preferably implement the method of FIG. 3, to be described further below.

In one embodiment of the invention we introduce a notation which allows us to represent any number to any number of significant decimal places in such a way that the lexicographical ordering will equal to the correct mathematical ordering. In one embodiment an overhead of only eight characters are used in addition to the significant decimal places. For example, utilizing base 10, the number 1,234,567,890,000,000,000,000,000 will only require 9 characters for the significant digits and another eight to represent the magnitude (by way of exponent) and the sign of the number and exponent. Using a higher base, such as base 64, or allowing fewer digits for the exponent, will further reduce the number of characters.

Complementary digits are used are used to correct the ordering of negative numbers, as required, where the term complementary digits as used throughout this document is defined as the result of subtracting the digit to be complemented from the base, and further subtracting 1. For example, in base 10 a 0 replaces a 9; a 1 replaces an 8; and a 2 replaces a 7.

As described above, every real number which has a finite decimal expansion may be expressed as a fixed number of whole digits, followed by fractional digits, multiplied by a base to an exponent. Utilizing base 10, as a non-limiting example, every non-zero number may be expressed as 10̂z*#x.yyy where # is a + or − sign, “x” is a single non-zero digit, positive or negative, yyy is any number of digits as required; and the exponent “z” is an integer, which may be zero, positive or negative. For example:

0.025=10̂(−3)*25

123.45=−10̂2*1.2345

In one non-limiting embodiment, real numbers are converted to lexicographically sortable strings using the following notation:
“n” for a negative number and “p” for a positive number, taking advantage of the lexicographical ordering of the letters n and p;
“E” to represent the term exponent, for cosmetic clarity;
zzz to represent the exponent value to the predetermined base. Preferably zzz is up to 3 digits, thus being sufficient in base 10 or above to represent virtually any magnitude of number of any practical use. Each digit of zzz is replaced with its complement if the exponent and number have opposite signs in order that negative exponents will sort correctly;
* to indicate the end of exponent, for cosmetic clarity;
A single non-zero digit in the desired base, replaced with its complement if the overall number is negative;
“.” to represent the end of the whole digits, for cosmetic clarity;
yyyy—any number of digits—with each digit replaced with its complement if the overall number is negative so that the ordering is correct; and
if the number is negative a trailing symbol “x”, to ensure that for negative numbers a shorter number like −3.45 is actually higher than a longer number such as −3.456;
If the number is 0, a predetermined character, such as the letter “o” is used for the number in place of the above algorithm. The choice of predetermined character takes advantage of the underlying character ordering, since for example, “n”<“o”<“p”.

In an alternative embodiment, one or more of the cosmetic clarity characters are not utilized.

Table I below illustrates a non-limiting example of a representation (also known as “serialization” of various numbers as strings, utilizing base 10, in according with the above notation.

TABLE I

| Decimal notation | Scientific notation | Serialization |
|---|---|---|
| −10¹⁰⁰ | 10¹⁰⁰ * (−1.) | nEn899 * 8.x |
| −123.457 | 10⁵ * (−1.23457) | nEn994 * 8.76542x |
| −123.456 | 10⁵ * (−1.23456) | nEn994 * 8.76543x |
| −1 | 10⁰ * (−1.) | nEn999 * 8.x |
| −0.01234 | 10⁻² * (−1.234) | nEp002 * 8.765x |
| −0.0123 | 10⁻² * (−1.23) | nEp002 * 8.76x |
| −0.0000000000123 | 10⁻¹¹ * (−1.23) | nEp011 * 8.76x |
| 0 | 10⁰ * 0 | o |
| 0.000234 | 10⁻⁴ * 2.34 | pEn995 * 2.34 |
| 0.234 | 10⁻¹ * 2.34 | pEn998 * 2.34 |
| 5 | 10⁰ * 5 | pEp000 * 5. |

Utilizing the above, we divide the target range of real numbers into five ranges each of which has a different prefix, and in each of which the lowest number in the range is represented xEx000*1. In particular, the prefixes lexicographically sort the numbers into the following ranges:

−10̂1000<number<=−1; prefix: nEn

−1<number<0; prefix: nEp

Number=0; prefix: o

0<number<1; prefix pEn

1<=number<10̂1000; prefix pEp

FIG. 2 illustrates a high level flow chart of a method of encoding numbers to a string, implemented by computing device 20 of FIG. 1, in accordance with a principle of the invention, in which the number to be encoded is denoted P, drawn from number portion 72 of memory 70.

In stage 1000, P is input from memory portion 72. In stage 1010, P is compared to 0. In the event P=0, in stage 1020, P is encoded to a predetermined character string. In one embodiment the predetermined character string representing a zero value is “o”. In stage 1130, the character string of stage 1020 is returned as a lexicographically sortable encoded number. Advantageously, the predetermined character string of stage 1020 is selected so as to be lexicographically ordered between the representation of negative numbers and positive numbers described further below in relation to stage 1080.

In the event that in stage 1010, P≠0, in stage 1030 Q is set to be equal to the absolute value of P. In particular, if P is negative, multiplied P by −1. In stage 1040, the log_{base} Q is calculated and rounded it down to the nearest integer and denoted zzz, the exponent value. The base of the logarithmic function is in one embodiment 10. In another embodiment, the base of the logarithmic function is one of 2, 16, 64 and 256. For clarity of the rounding down, in an example of base 10, −0.5 is rounded down to −1. zzz is preferably set to a predetermined number of digits, by adding leading zeros as required. In one embodiment zzz is set to a 3 digit number.

In stage 1050, Q of stage 1030 is divided by the basêzzz, where the base is the base of the logarithm of stage 1040, and zzz is the output of stage 1040. Optionally, the resultant digits are serialized by placing a delimiter to the right of the first digit. In one embodiment the delimiter is a period.

In stage 1060, the sign of zzz of stage 1040 is compared to the sign of P of stage 1000. In the event that the sign of zzz is not equal to the sign of P, in stage 1070, each of the digits of zzz are replaced with the complementary digit, and if P is negative, then the sign of zzz is reversed, i.e. zzz=−zzz, since for negative numbers a positive exponent gives a smaller number than a negative exponent.

Thus, in the event of a positive number with a negative exponent, the digits are complemented, since a larger exponent is associated with a smaller number. Similarly, in the event of a negative number with a positive exponent, the digits are complemented, since a larger exponent is associated with a smaller number.

In the event that in stage 1060 the sign of zzz=the sign of P, or after stage 1070, in stage 1080 a prefix is prepared. The prefix is set to “n” if P<0, or another character indicative of a negative number; and the prefix is set to “p” if P>0, or another character indicative of a positive number, which preferably is lexicographically greater than the character indicative of a negative number. Optionally, the prefix is further concatenated with an indicator that an exponent form is used, such as an “E”. The prefix is further concatenated with “n”, or another character indicative of a negative number, if zzz<0; and is set to “p”, or another character indicative of a positive number, if zzz=>0 and to a intermediate character such as “o” if zzz=0. Finally, the absolute value of zzz is concatenated to the prefix with trailing zeros if required to pad it to the fixed number of exponent characters used such as three. zzz as used in stage 1080 may have been modified in stage 1070, and the modified value is thus applied.

In stage 1100, the sign of P of stage 1000 is examined. In the event that in stage 1100 the sign of P is negative, in stage 1110, the serialized digits of stage 1050 are each replaced with the complementary digit, and concatenated to the string of stage 1090. In particular, the complementary digit of a digit z=base−1−z. The string is further concatenated with a character whose lexicographical value is greater than any digits being utilized. In one embodiment the character whose value is greater than any digits being utilized is “x”. In stage 1130, the character string of stage 1010 is returned as a lexicographically sortable encoded number.

The serialized digits of stage 1050 are concatenated to the string of stage 1090. In stage 1130, the character string of stage 1020 is returned as a lexicographically sortable encoded number.

FIG. 3 illustrates a high level flow chart of an embodiment of a method of decoding numbers from a lexicographically sortable string according to a principle of the invention, and is intended to recreate the original number which has been encoded in accordance with the method of FIG. 2.

In stage 2000, the digits of the serialized string to be decoded are denoted R. The digits of R do not include the exponent characters, described above in relation to stage 1040. Any trailing characters having a value greater than a digit value are stripped off, thereby removing any character added in stage 1110.

In stage 2010, the first character of the prefix is examined and compared with n, i.e. the character selected to represent a negative number referred to above in stage 1080. In the event that the prefix is n, in stage 2020 the digits of R are replaced with their complements and R is replaced with −R. In the event that in stage 2010 the prefix lead in not n, or after stage 2020, in stage 2030 the balance of the prefix is examined. If the prefix of the exponent is En then each of the digits of the exponent are replaced with their complement.

In the event that in stage 2030 the balance of the prefix of the exponent is not En, or after stage 2040, in stage 2050 the lead of the prefix is compared with the trailer of the prefix. In the event that the lead of the prefix is not equal to the trailer of the prefix, then in stage 2060 the sign of the exponent is reversed, i.e. zzz=−zzz.

In the event that in stage 2050 the lead of the prefix is equal to the trailer of the prefix, or after stage 2060, in stage 2070 the number is formed as R*basêzzz, wherein the base is as described above in relation to stage 1040.

Thus, the present embodiments enable a computer implemented method of encoding numbers into strings such that positive and negative numbers of a range of magnitudes may be effectively and efficiently encoded in such a way that the lexicographical ordering of the encoding strings matches the numeric ordering.

It is appreciated that certain features of the invention, which are, for clarity, described in the context of separate embodiments, may also be provided in combination in a single embodiment. Conversely, various features of the invention which are, for brevity, described in the context of a single embodiment, may also be provided separately or in any suitable sub-combination.

Unless otherwise defined, all technical and scientific terms used herein have the same meanings as are commonly understood by one of ordinary skill in the art to which this invention belongs. Although methods similar or equivalent to those described herein can be used in the practice or testing of the present invention, suitable methods are described herein.

All publications, patent applications, patents, and other references mentioned herein are incorporated by reference in their entirety. In case of conflict, the patent specification, including definitions, will prevail. In addition, the materials, methods, and examples are illustrative only and not intended to be limiting.

The terms “include”, “comprise” and “have” and their conjugates as used herein mean “including but not necessarily limited to”.

It will be appreciated by persons skilled in the art that the present invention is not limited to what has been particularly shown and described hereinabove. Rather the scope of the present invention is defined by the appended claims and includes both combinations and sub-combinations of the various features described hereinabove as well as variations and modifications thereof, which would occur to persons skilled in the art upon reading the foregoing description.

I claim:

1. A computer implemented method of representing real numbers of positive and negative sign as a character string such that lexicographical ordering of the character string matches numeric ordering of the real numbers, the method comprising;
expressing the real number as at least one whole number followed by at least one fractional number, times a predetermined base to a whole number exponent; and
concatenating, in a predetermined order:
a representation of the sign of the real number;
a representation of the numeric ordering responsive to the exponent;
a representation of the exponent; and
a representation of the whole numbers followed by a representation of the at least one fractional number.

2. A computer implemented method according to claim 1, wherein said whole number exponent is constituted of a predetermined number of digits.

3. A computer implemented method according to claim 1, wherein said predetermined number of digits of said whole number is 1.

4. A computer implemented method according to claim 1, wherein said representation of the sign of the real number is such that the representation of a negative real number is lexicographically ordered before the representation of a positive real number.

5. A computer implemented method according to claim 4, further comprising:
replacing, in the event than the real number is zero, said concatenation with a predetermined character string, said character string being selected so as to be lexicographically ordered between said representation of a negative real number and the representation of a positive real number.

6. A computer implemented method according to claim 1, wherein in the event that the sign of the real number does not equal the sign of the whole number exponent, said representation of the exponent is constituted of the complement of the digits of the exponent.

7. A computer implemented method according to claim 1, wherein in the event that said real number is a negative number, said representation of the whole numbers followed by fractional numbers is constituted of the complement of the digits of the whole number

8. A computer implemented method according to claim 1, wherein said predetermined base is one of base 2, 10, 16, 64 and 256.

9. A computer-readable medium containing instructions for controlling a data processing system to perform a computer implemented method of representing real numbers of positive and negative sign as a character string such that lexicographical ordering of the character string matches numeric ordering of the real numbers, the computer implemented method comprising;
expressing the real number as at least one whole number followed by at least one fractional number, times a predetermined base to a whole number exponent; and
concatenating, in a predetermined order:
a representation of the sign of the real number;
a representation of the numeric ordering responsive to the exponent;
a representation of the exponent; and
a representation of the whole numbers followed by a representation of the at least one fractional number.

10. A computer-readable medium according to claim 9, wherein said whole number exponent is constituted of a predetermined number of digits.

11. A computer-readable medium according to claim 9, wherein said predetermined number of digits of said whole number is 1.

12. A computer-readable medium according to claim 9, wherein said representation of the sign of the real number is such that the representation of a negative real number is lexicographically ordered before the representation of a positive real number.

13. A computer-readable medium according to claim 9, wherein said computer implemented method further comprises:
replacing, in the event than the real number is zero, said concatenation with a predetermined character string, said character string being selected so as to be lexicographically ordered between said representation of a negative real number and the representation of a positive real number.

14. A computer-readable medium according to claim 9, wherein said computer implemented method further comprises:
in the event that the sign of the real number does not equal the sign of the whole number exponent, said representation of the exponent is constituted of the complement of the digits of the exponent.

15. A computer-readable medium according to claim 9, wherein said computer implemented method further comprises:
in the event that said real number is a negative number, said representation of the whole numbers followed by fractional numbers is constituted of the complement of the digits of the whole number

16. A computer-readable medium according to claim 9, wherein said predetermined base is one of 2, 10, 16, 64 and 256.

17. A computing platform operative to represent real numbers of positive and negative sign as a character string such that lexicographical ordering of the character string matches numeric ordering of the real numbers, the computing platform comprising a computer and a memory, the computer being operative to:
express the real number as at least one whole number followed by at least one fractional number, times a predetermined base to a whole number exponent; and
concatenate, in a predetermined order:
a representation of the sign of the real number;
a representation of the numeric ordering responsive to the exponent;
a representation of the exponent; and
a representation of the whole numbers followed by a representation of the at least one fractional number.

18. A computing platform according to claim 17, wherein said whole number exponent is constituted of a predetermined number of digits.

19. A computing platform according to claim 17, wherein said predetermined number of digits of said whole number is 1.

20. A computing platform according to claim 17, wherein said representation of the sign of the real number is such that the representation of a negative real number is lexicographically ordered before the representation of a positive real number.

21. A computing platform according to claim 17, wherein said computer is further operative to:
replace, in the event than the real number is zero, said concatenation with a predetermined character string, said character string being selected so as to be lexicographically ordered between said representation of a negative real number and the representation of a positive real number.

22. A computing platform according to claim 17, wherein in the event that the sign of the real number does not equal the sign of the whole number exponent, said representation of the exponent is constituted of the complement of the digits of the exponent.

23. A computing platform according to claim 17, wherein said computer is further operative to:
in the event that said real number is a negative number, said representation of the whole numbers followed by fractional numbers is constituted of the complement of the digits of the whole number

24. A computing platform according to claim 17, wherein said predetermined base is one of 2, 10, 16, 64 and 256.

25. A database system comprising, a core database capable of storing data records including strings and querying and sorting said strings lexicographically, an encoder module for converting numbers into strings such that a lexicographical ordering of the character string matches the numeric ordering of the real numbers, a decoder module for reversing the coding, where the encoder and decoder are coupled to the core database to provide a database system and wherein numbers may be stored and queried based on numeric value ranges.
